(19) United States
(12) Patent Application Publication
(10) Pub. No.: US 2007/0200011 A1
(43) Pub. Date: Aug. 30, 2007

(54) FUEL INJECTOR HAVING NOZZLE MEMBER WITH ANNULAR GROOVE

(75) Inventor: Daniel R. Ibrahim, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/362,865

(22) Filed: Feb. 28, 2006

(51) Int. Cl. F02M 63/00

(52) U.S. Cl. 239/533.2

(57) ABSTRACT

A fuel injector for an engine having at least one combustion chamber is disclosed. The fuel injector has a needle valve element with a base end and a tip end. The tip end of the fuel injector has a valve sealing surface. The fuel injector also has a control chamber located at the base end of the needle valve element, and a nozzle member. The nozzle member has a central bore configured to slidingly receive the needle valve element, and a valve seating surface configured for engagement with the valve sealing surface of the needle valve element. The nozzle member also has at least one radially disposed injection orifice and an annular groove located within the valve seating surface. The injection orifice is configured to communicate the central bore with the at least one combustion chamber.

### TECHNCIAL FIELD

The present disclosure is directed to a fuel injector and, more particularly, to a fuel injector having a nozzle member with an annular groove. Background

Common rail fuel systems typically employ multiple closed-nozzle fuel injectors to inject high pressure fuel into combustion chambers of an engine. Each of these fuel injectors include a nozzle assembly having a cylindrical bore with a nozzle supply passageway and at least one nozzle spray orifice. A needle check valve is reciprocatingly disposed within the cylindrical bore and biased toward a closed position where the nozzle spray orifice is blocked. To inject fuel, the needle check valve is selectively moved to open the nozzle spray orifice, thereby allowing high pressure fuel to spray from the nozzle supply passageway into the associated combustion chamber.

During operation of the closed-nozzle fuel injectors, constant movement of the needle check valve between the open and closed positions and the forces associated therewith may cause the needle check valve and nozzle assembly to wear, resulting in shortened component life and fuel injection variability. This injection variability may result in decreased performance of the fuel injector, which may be manifested through reduced engine efficiency and increased exhaust emissions.

One method implemented by engine manufacturers to reduce the effects associated with wear of the needle check valve and nozzle assembly is described in U.S. Pat. No. 6,789,783 (the '783 patent) issued to Boecking on Sep. 14, 2004. The '783 patent describes a fuel injection valve having a valve needle for closing an injection opening at a combustion chamber end of a valve needle bore. A valve seat at the combustion chamber end contacts a valve sealing surface on the valve needle when the valve needle is in a closed position, thereby sealing the injection opening. The valve seat is bordered by a first annular groove, which extends in a radial plane of the valve needle bore, and a second annular groove, which is disposed downstream of and parallel to this first annular groove. When in the closed position, the valve needle rests against the valve seat between the first and second annular grooves. In this manner, the two annular grooves delimit the hydraulically effective seat diameter of the valve needle, thereby retaining operational characteristics of the fuel injector even after deformation of the valve needle.

Although the fuel injection valve of the '783 patent may reduce the affects of valve needle deformation, it may do little to reduce wear of other fuel injection components. For example, the valve of the '783 patent does not address the problem of cavitation at or near the injection openings or the wear effects associated therewith.

The fuel injector of the present disclosure solves one or more of the problems set forth above.

### SUMMARY OF THE INVENTION

One aspect of the present disclosure is directed to a fuel injector for an engine having at least one combustion chamber. The fuel injector includes a needle valve element having a base end and. a tip end with a valve sealing surface. The fuel injector also includes a control chamber located at the base end of the needle valve element, and a nozzle member. The nozzle member includes a central bore configured to slidingly receive the needle valve element, and a valve seating surface configured for engagement with the valve sealing surface of the needle valve element. The nozzle member also includes at least one radially disposed injection orifice and an annular groove located within the valve seating surface. The at least one radially disposed injection orifice is configured to communicate the central bore with the at least one combustion chamber.

Another aspect of the present disclosure is directed to another fuel injector for an engine having at least one combustion chamber. The fuel injector includes a needle valve element having a base end and a tip end with a valve sealing surface. The fuel injector also includes a control chamber located at the base end of the needle valve element, and a nozzle member. The nozzle member includes a central bore configured to slidingly receive the needle valve element, and a valve seating surface configured for engagement with the valve sealing surface of the needle valve element. The nozzle member also includes at least one radially disposed injection orifice configured to communicate the central bore with the at least one combustion chamber, and an interior annular groove disposed at approximately the same axial location as the at least one radially disposed injection orifice.

Another aspect of the present disclosure is directed to a method of injecting fuel into a combustion chamber of an engine. The method includes pressurizing fuel, and relieving pressure from a base end of a needle valve element to allow a flow of pressurized fuel through a central bore of a nozzle member to an annular groove. The method also includes radially redirecting the pressurized fuel from the annular groove into the combustion chamber.

### BRIEF DESCRIPTION OF THE DRAWINGS

FIG. 1 is a schematic and diagrammatic illustration of an exemplary disclosed fuel system;

FIG. 2 is a cross-sectional illustration of an exemplary disclosed fuel injector for the fuel system of FIG. 1; and

FIG. 3 is close-up cross-sectional illustration of an exemplary disclosed nozzle arrangement for use with the fuel injector of FIG. 2.

### DETAILED DESCRIPTION

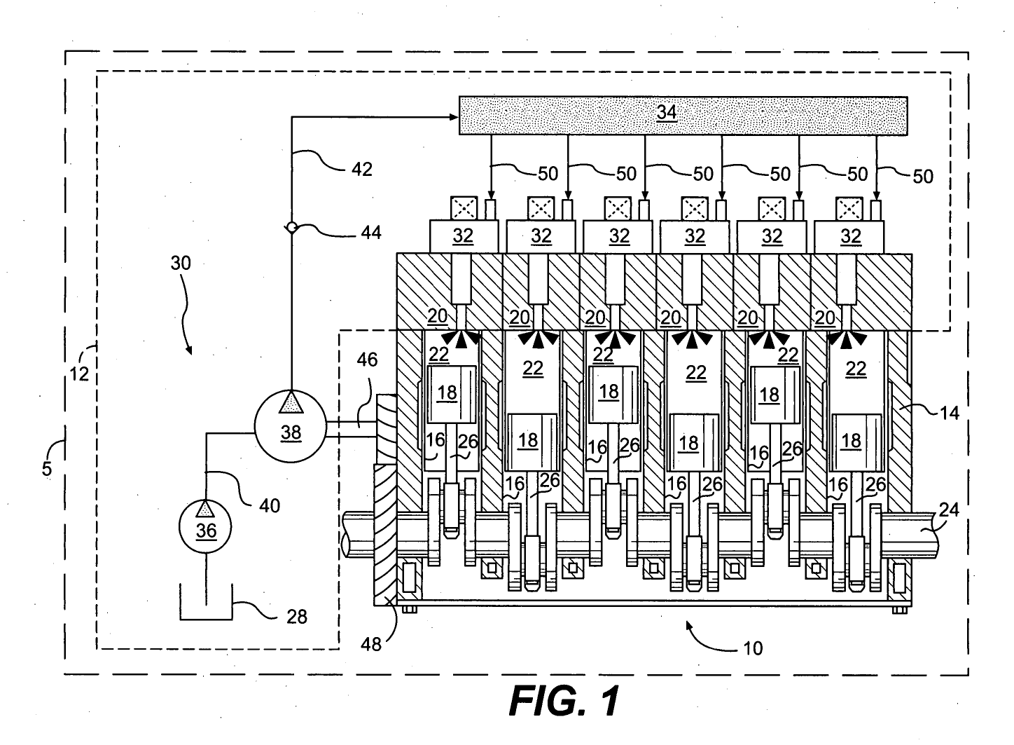

FIG. 1 illustrates a machine 5 having an engine 10 and an exemplary embodiment of a fuel system 12. Machine 5 may be a fixed or mobile machine that performs some type of operation associated with an industry such as mining, construction, farming, power generation, transportation, or any other industry known in the art. For example, machine 5 may embody an earth moving machine, a generator set, a pump, or any other suitable operation-performing machine.

For the purposes of this disclosure, engine 10 is depicted and described as a four-stroke diesel engine. One skilled in the art will recognize, however, that engine 10 may be any other type of internal combustion engine such as, for example, a gasoline or a gaseous fuel-powered engine. Engine 10 may include an engine block 14 that at least partially defines a plurality of cylinders 16, a piston 18 slidably disposed within each cylinder 16, and a cylinder head 20 associated with each cylinder 16.

Cylinder 16, piston 18, and cylinder head 20 may form a combustion chamber 22. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, a “V” configuration, or any other suitable configuration.

As also shown in FIG. 1, engine 10 may include a crankshaft 24 that is rotatably disposed within engine block 14. A connecting rod 26 may connect each piston 18 to crankshaft 24 so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into each combustion chamber 22. Specifically, fuel system 12 may include a tank 28 configured to hold a supply of fuel, and a fuel pumping arrangement 30 configured to pressurize the fuel and direct the pressurized fuel to a plurality of fuel injectors 32 by way of a common rail 34. It is contemplated that additional or different components may be included within fuel system 12, if desired, such as, for example, debris filters, water separators, makeup valves, relief valves, priority valves, and energy regeneration devices.

Fuel pumping arrangement 30 may include one or more pumping devices that function to increase the pressure of fuel drawn from tank 28 and direct one or more pressurized streams of fuel to common rail 34. In one example, fuel pumping arrangement 30 includes a low pressure source 36 and a high pressure source 38 fluidly connected in series by way of a fuel line 40. Low pressure source 36 may embody a transfer pump configured to provide low pressure feed to high pressure source 38. High pressure source 38 may be configured to receive the low pressure feed and increase the pressure of the fuel to the range of about 30-300 MPa. High pressure source 38 may be connected to common rail 34 by way of a fuel line 42. A check valve 44 may be disposed within fuel line 42 to provide for unidirectional flow of fuel from fuel pumping arrangement 30 to common rail 34.

One or both of low and high pressure sources 36, 38 may be operatively connected to engine 10 and driven by crankshaft 24. Low and/or high pressure sources 36, 38 may be connected with crankshaft 24 in any manner readily apparent to one skilled in the art where a rotation of crankshaft 24 will result in a corresponding rotation of a pump drive shaft. For example, a pump driveshaft 46 of high pressure source 38 is shown in FIG. 1 as being connected to crankshaft 24 through a gear train 48. It is contemplated, however, that one or both of low and high pressure sources 36, 38 may alternatively be driven electrically, hydraulically, pneumatically, or in any other appropriate manner.

Fuel injectors 32 may be disposed within cylinder heads 20 and fluidly connected to common rail 34 by a plurality of distribution lines 50. Each fuel injector 32 may be operable to inject an amount of pressurized fuel into an associated combustion chamber 22 at predetermined timings, fuel pressures, and fuel flow rates. The timing of fuel injection into combustion chamber 22 may be synchronized with the motion of piston 18. For example, fuel may be injected as piston 18 nears a top-dead-center position during a compression stroke to allow for compression-ignited-combustion of the injected fuel. Alternatively, fuel may be injected as piston 18 begins the compression stroke heading towards a top-dead-center position for homogenous charge compression ignition operation. Fuel may also be injected as piston 18 is moving from a top-dead-center position towards a bottom-dead-center position during an expansion stroke for a late post injection to create a reducing atmosphere for aftertreatment regeneration.

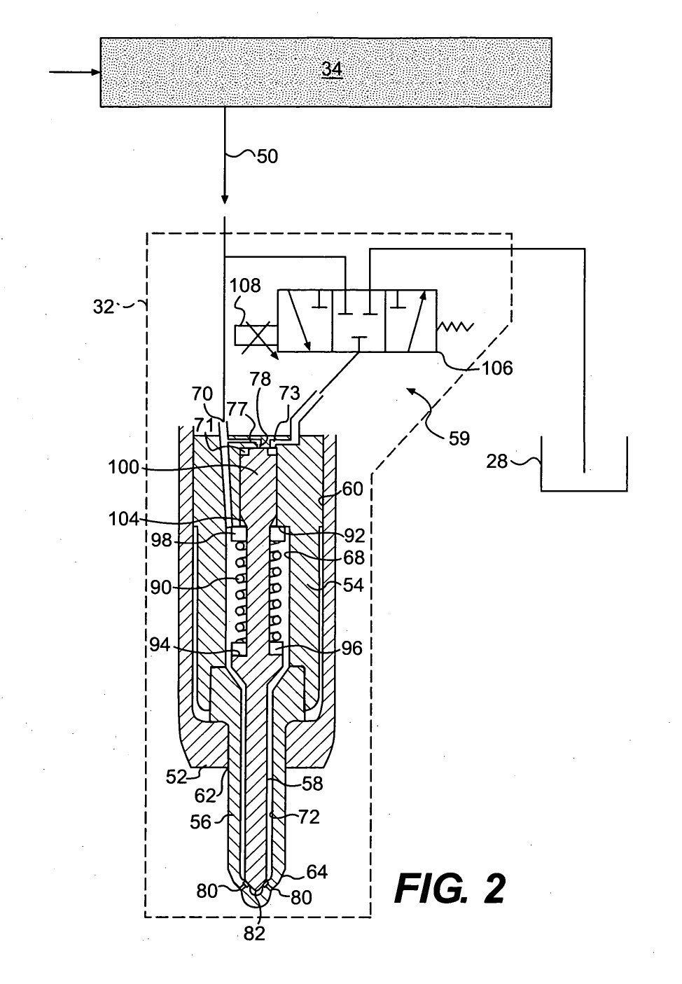

As illustrated in FIG. 2, each fuel injector 32 may embody a closed nozzle electronically actuated and controlled fuel injector. Specifically, each fuel injector 32 may include an injector body 52 housing a guide 54, a solenoid actuator 59, a nozzle member 56, and a needle valve element 58. It is contemplated that each fuel injector 32 may include additional or different components than those illustrated in FIG. 2, if desired, such as, for example, additional solenoid actuators and additional valve elements. It is further contemplated that fuel injectors 32 may alternatively embody other types of fuel injection devices such as, for example, mechanically actuated electronically controlled injectors, digitally controlled fuel valves, or any other type of fuel injector known in the art.

Injector body 52 may be a cylindrical member configured for assembly within cylinder head 20. Injector body 52 may have a central bore 60 for receiving guide 54 and nozzle member 56, and an opening 62 through which a tip end 64 of nozzle member 56 may protrude. A sealing member such as, for example, an o-ring (not shown) may be disposed between guide 54 and nozzle member 56 to restrict fuel leakage from fuel injector 32.

Guide 54 may also be a cylindrical member having a central bore 68 configured to receive needle valve element 58, and a control chamber 71. Central bore 68 may act as a pressure chamber, holding pressurized fuel that is supplied from a fuel supply passageway 70. During injection, the pressurized fuel from distribution line 50 may flow through fuel supply passageway 70 and central bore 68 to nozzle member 56. It is contemplated that fluid passageway 70 may alternatively be routed through and directly flow controlled by solenoid actuator 59, if desired.

Control chamber 71 may be selectively drained of or supplied with pressurized fuel. Specifically, a control passageway 73 may fluidly connect control chamber 71 and solenoid actuator 59 for draining and filling of control chamber 71. Control chamber 71 may also be supplied with pressurized fluid via a supply passageway 77 and a port 78 that is axially aligned with needle valve element 58 and in communication with fuel supply passageway 70. A diameter of port 78 may be less than a diameter of control passageway 73 and supply passageway 77 to allow for a pressure drop within control chamber 71 when control passageway 73 is drained of pressurized fuel.

Solenoid actuator 59 may be configured to control the flow of fuel into and out of control chamber 71. In particular solenoid actuator 59 may include a three position proportional valve element 106 disposed within control passageway 73 between control chamber 71 and tank 28. Proportional valve element 106 may be spring biased and solenoid actuated to move between a first position at which fuel is allowed to flow from control chamber 71 to tank 28, a second position at which pressurized fuel from distribution line 50 flows through control passageway 73 into control chamber 71, and a third position at which fuel flow through control passageway 73 is blocked. The position of proportional valve element 106 between the first, second, and third positions may determine a flow rate of the fuel through control passageway 73, as well as the flow direction. Proportional valve element 106 may be movable to any position between the first, second, and third positions in response to an electric current applied to a solenoid 108 associated with proportional valve element 106. It is contemplated that proportional valve element 106 may alternatively be hydraulically actuated, mechanically actuated, pneumatically actuated, or actuated in any other suitable manner. It is further contemplated that proportional valve element 106 may be a two-position valve element that is movable between only a control chamber draining position and a control chamber filling position or between only a control chamber draining position and a blocked position, if desired.

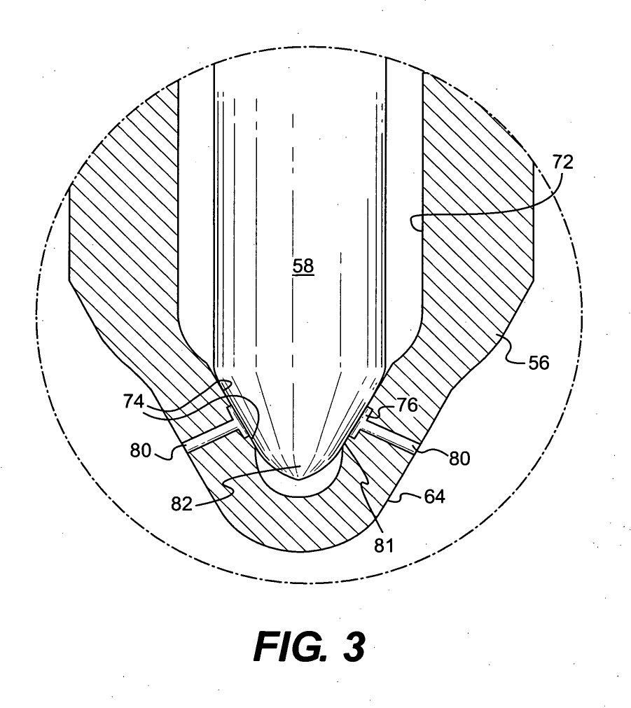

Nozzle member 56 may likewise be a cylindrical member, having a central bore 72 of blind depth that is configured to receive needle valve element 58. As illustrated in the close-up of FIG. 3, nozzle member 56 may include a seating surface 74 located toward tip end 64 of nozzle member 56, and an interior annular groove 76 and one or more orifices 80 disposed within seating surface 74. A diameter of interior annular groove 76 may be greater than a diameter of orifices 80 such that orifices 80 may be recessed within a surface of interior annular groove 76. Interior annular groove 76 may be located at approximately the same axial location as an inlet of orifices 80 and may be configured to radially redirect pressurized fuel from central bore 72 through orifices 80 to spray into an associated combustion chamber 22 of engine 10.

Needle valve element 58 may be an elongated cylindrical member that is slidingly disposed within housing guide 54 and nozzle member 56. Needle valve element 58 may be axially movable between a first position at which a sealing surface 81 located at a tip end 82 of needle valve element 58 engages seating surface 74 to block a flow of fuel through interior annular groove 76 and orifices 80, and a second position at which orifices 80 are open to a flow of fuel into combustion chamber 22. When in the first position, sealing surface 81 may engage seating surface 74 both at upstream and downstream locations relative to interior annular groove 76. It is contemplated, however, that sealing surface 81 may alternatively engage seating surface 74 at only one of the upstream and downstream locations, if desired.

Needle valve element 58 may be normally biased toward the first position. In particular, as seen in FIG. 2, each fuel injector 32 may include a spring 90 disposed between a stop 92 of guide 54 and a seating surface 94 of needle valve element 58 to axially bias tip end 82 toward the orifice-blocking position. A first spacer 96 may be disposed between spring 90 and stop 92, and a second spacer 98 may be disposed between spring 90 and seating surface 94 to reduce wear of the components within fuel injector 32.

Needle valve element 58 may have multiple driving hydraulic surfaces. In particular, needle valve element 58 may include a hydraulic surface 100 tending to drive needle valve element 58 toward the first or orifice-blocking position when acted upon by pressurized fuel within control chamber 71, and a hydraulic surface 104 that tends to oppose the bias of spring 90 and drive needle valve element 58 in the opposite direction toward the second or orifice-opening position. When biased toward the second position, needle valve element 58 may be configured to substantially restrict or even block off the flow of fuel through supply passageway 77.

### INDUSTRIAL APPLICABILITY

The fuel injector of the present disclosure has wide applications in a variety of engine types including, for example, diesel engines, gasoline engines, and gaseous fuel-powered engines. The disclosed fuel injector may be implemented into any engine that utilizes a pressurizing fuel system wherein it may be advantageous to minimize cavitation in a nozzle tip of the fuel injector. The disclosed fuel injector may minimize cavitation in the nozzle tip by increasing a flow area at a location of directional flow change, which may function to reduce a flow velocity at that location and, thereby, the likelihood of cavitation. The operation of fuel injector 32 will now be explained.

Needle valve element 58 may be moved by an imbalance of force generated by fluid pressure. For example, when needle valve element 58 is seated against seating surface 74 in the first or orifice-blocking position, pressurized fuel from fuel supply and control passageways 77 and 73 may flow into control chamber 71 to act on hydraulic surface 100. Simultaneously, pressurized fuel from fuel supply passageway 70 may flow into central bore 68 in anticipation of injection. The force of spring 90 combined with the hydraulic force created at hydraulic surface 100 may be greater than an opposing force created at hydraulic surface 104 thereby causing needle valve element 58 to remain in the first position and block fuel flow through interior annular groove 76 and orifices 80. To open interior annular groove 76 and orifices 80 to a flow of fuel and initiate the injection of the fuel from central bore 68 into combustion chamber 22, solenoid actuator 59 may selectively move proportional valve element 106 to drain pressurized fuel away from control chamber 71 and hydraulic surface 100. This decrease in pressure acting on hydraulic surface 100 may allow the opposing force acting across hydraulic surface 104 to overcome the biasing force of spring 90, thereby moving sealing surface 81 of needle valve element 58 away from seating surface 74.

The location of interior annular groove 76 may reduce the likelihood of cavitation within nozzle member 56 and improve the performance of fuel injectors 32. In particular, because interior annular groove 76 is located at approximately the same axial location as the inlets of orifices 80, where the pressurized fuel changes flow directions from substantially axial to substantially radial, the velocity of the fuel flow in that location may be reduced. That is, the increased flow area at the inlets of orifices 80 facilitated by the presence of interior annular groove 76 may function to reduce the velocity of fuel flow therethrough. A reduction in cavitation within nozzle member 56 may reduce the amount of wear at the inlets of orifices 80 and the associated affects on flow variability and component life. In addition, because interior annular grooves 76 and orifices 80 are located within the engagement area of seating and sealing surfaces 74, 81 rather than at the borders of the engagement area, the likelihood of fuel unintentionally leaking from nozzle member 56 may be low. Further, because interior annular groove 76 may fluidly communicate orifices 80 with each other, the distribution of fuel spraying from fuel injector 32 into combustion chamber 22 may be improved.

It will be apparent to those skilled in the art that various modifications and variations can be made to the fuel injector of the present disclosure without departing from the scope of the disclosure. Other embodiments will be apparent to those skilled in the art from consideration of the specification and practice of the fuel injector disclosed herein. It is intended that the specification and examples be considered as exemplary only, with a true scope of the invention being indicated by the following claims and their equivalents.

1. A fuel injector for an engine having at least one combustion chamber, comprising:
a needle valve element having a base end and a tip end with a valve sealing surface; and
a nozzle member including:
a central bore configured to slidingly receive the needle valve element;
a valve seating surface configured for engagement with the valve sealing surface of the needle valve element;
at least one radially disposed injection orifice located within the valve seating surface and being configured to communicate the central bore with the at least one combustion chamber; and
an annular groove disposed within the valve seating surface,
the annular groove being flanked by both an upstream location of the valve seating surface and a downstream location of the valve seating surface, and
the valve sealing surface being configured to engage the valve seating surface at only one of the upstream and downstream locations of the valve seating surface.

2. The fuel injector of claim 1, wherein the annular groove is disposed at approximately the same axial location as the at least one radially disposed injection orifice.

3. The fuel injector of claim 1, wherein the at least one radially disposed injection orifice is recessed within a surface of the annular groove.

4. The fuel injector of claim 1, wherein:
the at least one radially disposed injection orifice is a first radially disposed injection orifice;
the fuel injector includes a second radially disposed injection orifice; and
the annular groove fluidly communicates the first and second radially disposed injection orifices.

5. The fuel injector of claim 1, wherein an axial length of the annular groove along the valve seating surface is greater than a diameter of the at least one radially disposed injection orifice.

6. The fuel injector of claim 1, wherein a flow of fuel through the at least one radially disposed injection orifice is blocked when the needle valve element is moved to a first position.

7. The fuel injector of claim 6, wherein the valve sealing surface of the needle valve element and the seating surface of the nozzle member are engaged only at the upstream location when the needle valve element is in the first position.

8. A fuel injector for an engine having at least one combustion chamber, comprising:
a needle valve element having a base end and a tip end with a valve sealing surface; and
a nozzle member including:
a central bore configured to slidingly receive the needle valve element;
a valve seating surface configured for engagement with the valve sealing surface of the needle valve element;
at least one radially disposed injection orifice configured to communicate the central bore with the at least one combustion chamber; and
an interior annular groove disposed at approximately the same axial location as the at least one radially disposed injection orifice,
the interior annular groove being flanked by both an upstream location of the valve seating surface and a downstream location of the valve seating surface, and
the valve sealing surface being configured to engage the valve seating surface only at the upstream location of the valve seating surface.

9. The fuel injector of claim 8, wherein:
the at least one radially disposed injection orifice is a first radially disposed injection orifice;
the fuel injector includes a second radially disposed injection orifice; and
the interior annular groove fluidly communicates the first and second radially disposed injection orifices.

10. The fuel injector of claim 8, wherein an axial length of the interior annular groove along the valve seating surface is greater than a diameter of the at least one radially disposed injection orifice.

11. A method of injecting fuel into a combustion chamber of an engine, the method comprising:
pressurizing fuel;
relieving pressure from a base end of a needle valve element to allow a flow of pressurized fuel through a central bore of a nozzle member to an annular groove having a substantially rectangular cross-section; and
radially redirecting the pressurized fuel from the annular groove into the combustion chamber.

12. The method of claim 11, wherein radially redirecting the pressurized fuel includes redirecting the pressurized fuel through at least one injection orifice recessed within a surface of the annular groove.

13. The method of claim 11, further including selectively engaging a needle valve element sealing surface with the seating surface of the nozzle member to disrupt a flow of fuel from the annular groove into the combustion chamber.

14. The method of claim 13, wherein selectively engaging a needle valve element sealing surface with the seating surface of the nozzle member blocks fluid communication of the annular groove with the central bore.

15. A machine, comprising:
an engine configured to generate a power output and having at least one combustion chamber;
a source of pressurized fuel; and
a fuel injector configured to inject pressurized fuel into the at least one combustion chamber and including:
a needle valve element having a base end and a tip end with a valve sealing surface;
a control chamber located at the base end of the needle valve element; and
a nozzle member including:
a central bore configured to slidingly receive the needle valve element;
a valve seating surface configured for engagement with the valve sealing surface of the needle valve element;
at least one radially disposed injection orifice located within the valve seating surface and being configured to communicate the central bore with the at least one combustion chamber; and
an annular groove disposed within the valve seating surface,
the annular groove being flanked by both an upstream location of the valve seating surface and a downstream location of the valve seating surface, and
the valve sealing surface being configured to engage the valve seating surface only at the upstream location of the valve seating surface.

16. The machine of claim 15, wherein:
the at least one radially disposed injection orifice is a first radially disposed injection orifice;
the fuel injector includes a second radially disposed injection orifice; and
the annular groove fluidly communicates the first and second radially disposed injection orifices.

17. The machine of claim 15, wherein an axial length of the annular groove along the valve seating surface is greater than a diameter of the at least one radially disposed injection orifice.

18. The machine of claim 15, wherein a flow of fuel through the at least one radially disposed injection orifice is blocked when the needle valve element is moved to a first position by an increase in pressure within the control chamber.

19. The machine of claim 18, wherein the valve sealing surface of the needle valve element and the seating surface of the nozzle member are engaged when the needle valve element is in the first position.

20. The machine of claim 15, wherein the at least one radially located injection orifice is recessed within a surface of the annular groove.

21. The fuel injector of claim 1, wherein a cross-section of the annular groove is substantially rectangular.

22. The fuel injector of claim 1, wherein a cross-section of the annular groove includes at least one substantially right angle.

23. The fuel injector of claim 8, wherein a cross-section of the interior annular groove is substantially rectangular.

24. The fuel injector of claim 8, wherein a cross-section of the interior annular groove includes at least one substantially right angle.

25. The machine of claim 15, wherein a cross-section of the interior annular groove is substantially rectangular.

26. The machine of claim 15, wherein a cross-section of the interior annular groove includes at least one substantially right angle.
